(19) United States
(12) Patent Application Publication
(10) Pub. No.: US 2015/0310476 A1
(43) Pub. Date: Oct. 29, 2015

(54) System and method for attention based currency

(71) Applicant: Elizabeth M. Gadwa, Greenfield, MA (US)

(72) Inventor: Elizabeth M. Gadwa, Greenfield, MA (US)

(21) Appl. No.: 14/695,235

(22) Filed: Apr. 24, 2015

Related U.S. Application Data
(60) Provisional application No. 61/983,563, filed on Apr. 24, 2014.

(51) Int. Cl. G06Q 30/02

(52) U.S. Cl. CPC G06Q 30/0226

(57) ABSTRACT

A system and method is disclosed of attention based cryptocurrency. Currency is generated or “mined” by a user listening, in one embodiment, to a streamed song, and upon listening to the entire selection, the user, the song artist and the streaming host server are each allocated a portion of Attention Based Currency (ABC) according to a formula which may vary based upon several factors, including the popularity of the selection, the number of simultaneous listeners and the number of times the song has been streamed. The formula chosen can promote listening to lesser known artists. The ABC can be traded or redeemed for products or services.

### CROSS REFERENCE TO RELATED APPLICATIONS

This application claims the benefit of U.S. Provisional Application 61/983,563 filed Apr. 24, 2014, which is incorporated herein by reference.

### FIELD OF INVENTION

The present invention relates broadly to a type of cryptocurrency, and more particularly to a cryptocurrency for a small value cryptocurrency generated by live human attention to streamed content.

### BACKGROUND OF THE INVENTION

All forms of exchange gain their value from scarcity. Whether we speak of gold mined in remote areas of the world, or the supply of dollars in circulation controlled by the Federal Reserve, traditional mediums of exchange would have no value if their quantity were not limited. Hyperinflation is the curse of an overabundance of currency—if a government begins printing too many bills to finance its own debts in times of war or economic distress, consumers pay the price and inflation results.

In recent years, the invention of the decentralized Internet currency known as Bitcoin represents a way to build the property of scarcity into an apparently limitless electronic medium. Individuals “mine” Bitcoin and other related crypto-currencies by solving a series of complex cryptographic hash equations. The activity of Bitcoin mining is time-consuming and processor-intensive. The total supply of Bitcoin is capped at the arbitrary limit of 21 million, and every four years the creation rate is halved. [Jerry Brito and Andrea Castillo (2013). “Bitcoin: A Primer for Policymakers”. Mercatus Center. George Mason University. p. 5. Retrieved 22 Oct. 2013.] Partly as a result of these rigorous constraints on the supply of currency, the value of Bitcoin has risen dramatically since its inception in 2009, with total market capitalization exceeding $7 billion as of Mar. 19, 2014. The value has fluctuated since then.

A crypto currency is a digital currency in which encryption techniques are used to regulate the generation of units of currency and verify the transfer of funds, operating independently of a central bank. A variety of cryptocurrencies are well known in the art, such as Bitcoin.

The present invention (called herein Attention Based Currency, or ABC) generated by monitoring the interactions of users with a content streaming application, for instance, a music streaming application. A user must be online and networked in order to participate. In this embodiment, each time a song is played to completion, one unit of ABC cryptocurrency is generated. (Units may be fractional portions of an ABC coin, (and referred to herein as ABC currency) meaning that it encompasses very low value transactions). Attention Based Currency (ABC) seeks to utilize a different scarce resource: the attention span of human beings. Users receive a share of this generated currency unit, as well as the streaming application host and the song artist.

Specifically, ABC measures the interactions of users with an online streaming music service, and mints currency units based upon these interactions. Because both the number of songs in the music service database and the number of potential and actual users are limited, conditions of scarcity are created. Rather than mining that requires the computation of complex mathematical equations, mining ABC depends on the simple act of listening to streamed content, such as a song in this example embodiment. User choice and user interaction with the system introduces a social variable that prevents the system from becoming too deterministic or predictable.

There is currently a wide array of proposed and actual alternative digital currencies: cryptocurrencies, bank-backed flat currencies and similar such currencies. While Bitcoin emphasizes anonymity and portability, the proposed implementation of ABC emphasizes convenience and ease of use. It reduces or eliminates transaction fees typically charged by banks and credit cards—costs otherwise charged to merchants and indirectly passed on to consumers.

ABC is designed for online transactions of information-based products whose value will most often be quite small, often less than a dollar. In other words, the ABC cryptocurrency is a way to monetize and capture value for information-based products and services currently too cheap to meter, which value can most often not be realized for investors or creators except through the imprecise and inefficient medium of online advertising.

Examples of products well suited to exchange for ABC include: digital images, videos, apps (software applications), electronic books, online gaming tokens, site subscriptions, and music downloads. In a preferred embodiment, ABC uses music streaming.

Why music?
Music is popular. Currency is about building a brand, as much as it is about security and stability. Bundling ABC cryptocurrency to a type of online service that is easy-to-use, well understood, and ubiquitous increases its strength.
Music is global. It is now possible to load in a selection of music that reflects the cultural and ethnic diversity of any region in the world or any period of time, or any style.
Music is an efficient use of bandwidth. Music is less bandwidth-intensive than streaming video or real-time online gaming, and can be enjoyed with different devices, in a variety of settings.
Music is not porn. Audio files may contain mature content, but they do not contain the types of graphic and explicit images often produced in unsafe and/or illegal conditions.
Music is complex, varied, and invites a lifelong relationship. Listeners/miners will return again and again, and find the experience rewarding at every step.

### BRIEF SUMMARY OF THE INVENTION

In a first embodiment, the present invention comprises a host media server, and ABC host and a client media player. A user may select desired media content, such as music or videos, for example, to be streamed to the users client media player from the host media server. In one embodiment, the host media server tells a ABC host about the transaction, identifying the user and the streamed content. The client media player also may communicate to the ABC host the identity of the media received and user identification information.

In a further embodiment, a ABC Host receives reporting from the client media player and host media server, verifies that the owner of the media served is contained within a database of enrolled media owners, and that the user of the client media player is an enrolled user in the ABC system. The ABC Host then may generate ABC currency based upon the identity of the streamed media content. In yet another embodiment, the amount of currency generated may vary depending upon one or more factors, such as, for example, the media content owner, popularity of the selected media content, promotional considerations, time of day of said streaming, and number of users simultaneously streaming said streamed media content.

In yet another embodiment, CAPTCHAs or voice prompts are periodically inserted into the streamed media content, requiring a response from the client media player user to confirm that he or she is human, and not a 'bot, and that they are attentive, i.e. listening in the case of music, to the streamed media content. In yet another embodiment, the ABC host does not generate any ABC Currency unless the host media server and//or the client media player confirms that the streamed media content was sent without interruption or skip.

In still another embodiment, the ABC currency generated is shared between the client media player user, the owner of the streamed media content and the host media server according to a selected sharing formula.

In yet another embodiment, the sharing of generated ABC currency is recorded in a blockchain containing a sequential record of all ABC currency transactions. In one embodiment, the blockchain is a distributed public ledger. In yet another embodiment, the blockchain is maintained by a central ABC host. In still another embodiment, the blockchain is maintained by a plurality of distributed peer to peer ABC Hosts.

In this respect, before explaining at least one embodiment of the invention in detail, it is to be understood that the invention is not limited in its application to the details of construction or to the arrangements of the Components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

FIG. 1 is a process flow block diagram of one embodiment of the present invention.

FIG. 1A is a more detailed block diagram showing a system operational flowchart of one embodiment of the present invention.

FIG. 1B is a system component diagram of one embodiment of the present invention.

FIG. 1C is a diagram of one embodiment a distributed host/Client ABC system.

FIG. 2 is a block diagram of a checkout transaction-processing model for ABC purchases.

FIG. 3 is a drawing of a user screen for a client music streaming application as part of an embodiment of the present invention.

FIG. 4 is a drawing of a song yield checker screen for a client streaming application of yet another part of an embodiment of the present invention.

FIG. 5 is a drawing of an account details screen for a client streaming application of yet another part of an embodiment of the present invention.

FIG. 6 is a drawing of a listening history screen for a client streaming application of yet another part of an embodiment of the present invention.

Various other objects, features and attendant advantages of the present invention will become fully appreciated as the same becomes better understood when considered in conjunction with the accompanying drawings, in which like reference characters designate the same or similar parts throughout the several views, and wherein:

### DETAILED DESCRIPTION OF THE INVENTION

Various exemplary embodiments of the present invention are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the invention or to imply that certain features are critical, essential, or even important to the structure or function of the invention. Rather, these terms are merely intended to highlight alternative or additional features that may or may not be utilized in a particular embodiment of the present invention.

The present invention is described more fully hereinafter with reference to the accompanying drawings, in which one or more exemplary embodiments of the invention are shown. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

According to one exemplary embodiment, the present invention relates to the combination of secure online cryptocurrency with a streaming content application such as, by way of example, an “online jukebox” that generates currency based upon plays of songs. This generated currency is referred to as Attention Based Currency (ABC). In yet another embodiment, the present invention includes a user sign-up method, digital wallet, and checkout process, which may be used with ABC.

While the embodiments described herein relate to streaming music content, it is to be understood that ABC may be used with any streaming content, such as videos, games, books and graphic novels—any content that may be streamed.

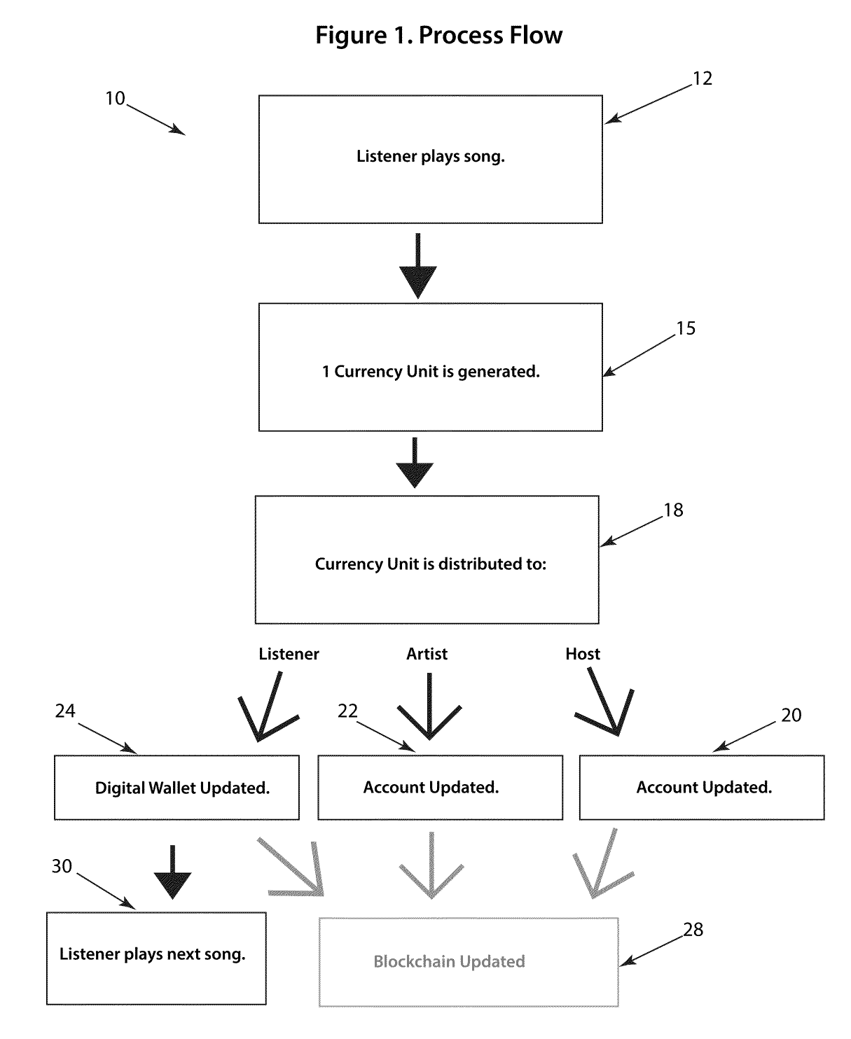

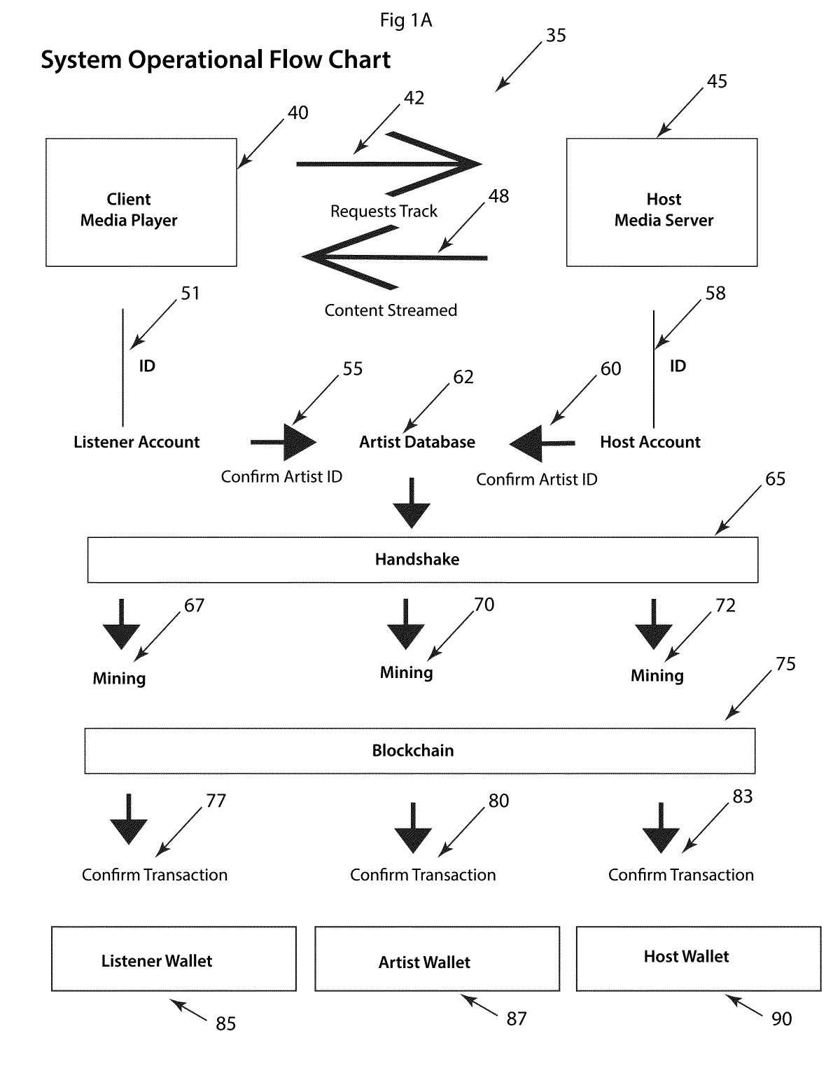

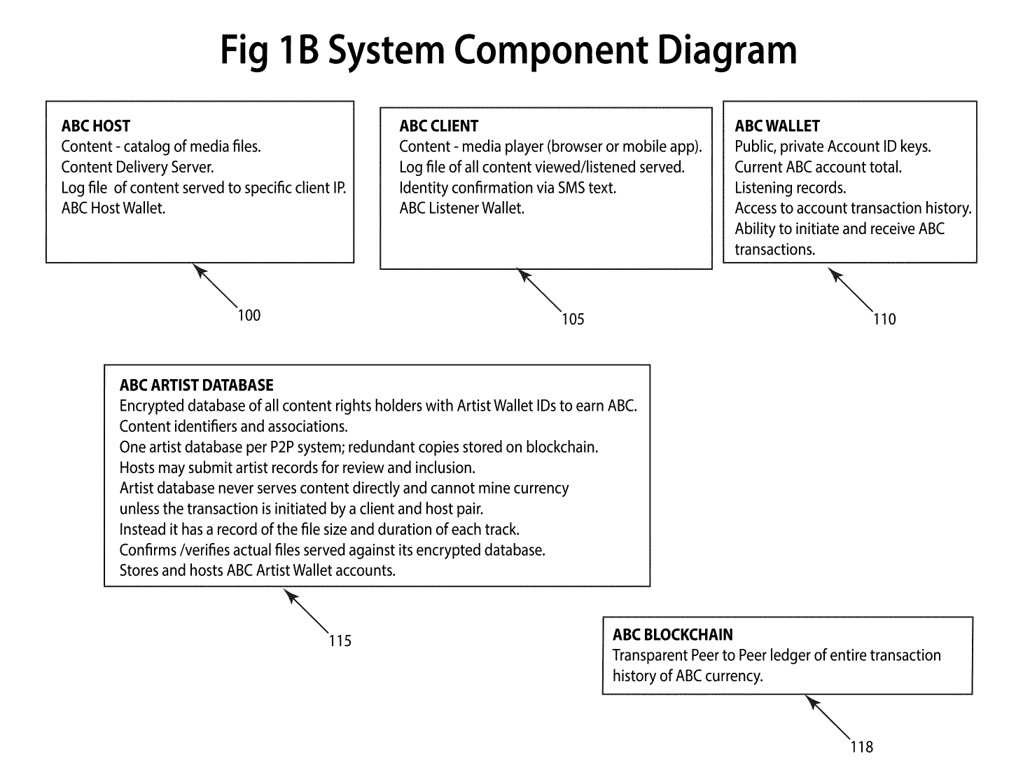

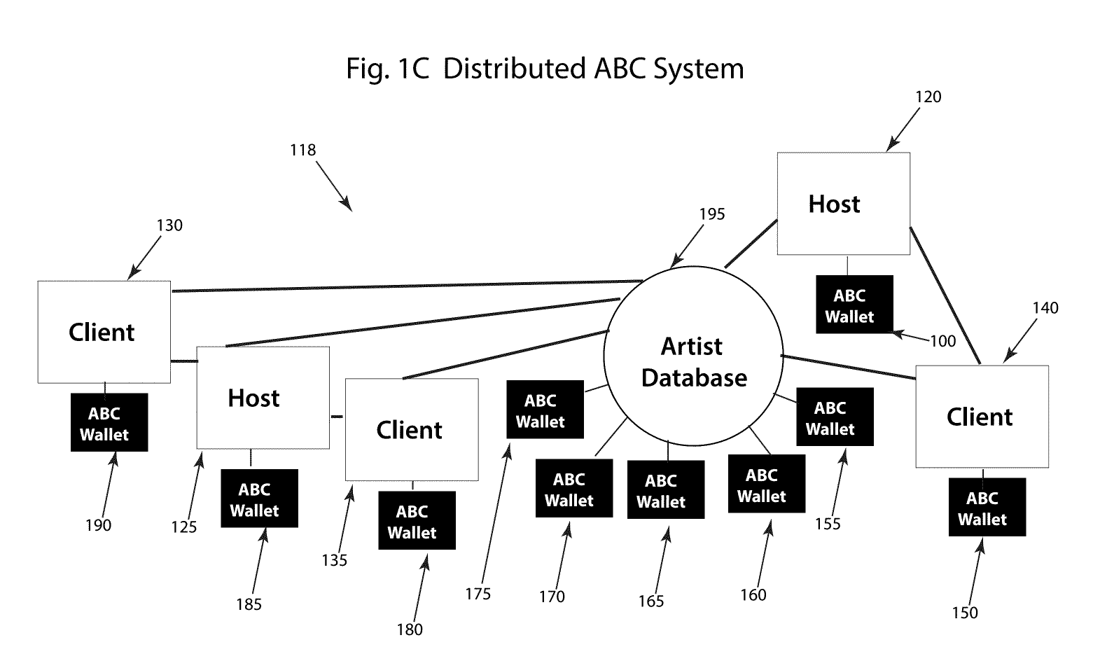

With reference to FIG. 1, a basic system process flow diagram 10 is shown. In its simplest form, a user requests and receives streaming content, such as music, from a content server 12. If the listener listens to the entire unit of content, an ABC unit of currency is generated 15. The amount of currency generated, which may be a fractional part of an ABC “coin”, may vary depending upon a formula used to generate the amount currency “mined” according to chosen criteria, which may include but is not limited to the popularity of the streamed selection, the time of day, the number of concurrent streamings of the chosen selection, whatever basis upon which operator of the system may choose.

Once the earned currency is generated, it is distributed in shared proportions between the listener, the artist(s) and the ABC host server. The proportions of the sharing are determined by whatever formula the ABC protocol specifies for the particular transaction. These proportions may be determined by a predetermined static formula or may vary dynamically according to variables and parameters specified by the ABC protocol. Upon distribution of the respective shares, the respective digital wallets of the ABC Host 20, the artist(s) 22 and the listener 24 are credited. Updating the digital wallets is confirmed by updating a blockchain 28, such as utilized by Bitcoin and other currencies known in the art. The blockchain stores a record of all ABC transactions and may be utilized to verify a digital wallet's contents.

Once the transaction has completed, the listener selects the next unit of streamed content 30 such as another song.

With reference to FIG. 1A, a more detailed operational flowchart 35 is shown. A user has a client media player 40 to receive streamed content The user selects the content he or she desires 42 from the host media server 45 and the desired content is streamed 48 to the client media player. Not shown, the client media player may be required to provide sign-in credentials to receive desired streamed content and to allow for the mining of currency.

The client media player 40 provides the ABC server (not shown) its listener account credentials 51 and the artist identification 55 for the content being streamed 48, utilizing a network connection. Similarly, the host media server 45 provides a cryptographic key 58 over a network confirming the artist ID for the content being streamed 48. If the ID and keys provided match 60, 55, and the artist ID is found in the ABC artist database 62 such that it is eligible for ABC currency mining, and the listener client media player 40 has an account, and the Host media server 45 is a participant in the ABC system, mining ABC currency may be authorized.

Currency distribution may be delayed (not shown) until a confirmation is received from the client media player 40 and/or the host media server 45 that the entire unit of streamed content has been played, not fast forwarded or only partially played, as such would not meet the attention based earning criteria.

Once the generation of ABC currency (“mining”) has been authorized 65, and the amount of currency for the particular transaction determined by context dependent formula the ABC system applies to determine the currency earning and distribution, the resulting distributions to the user 67, the artist(s) 70 and the media server 72 are posted to the blockchain 75 respectively. Once the transactions are confirmed and posted to the blockchain 77, 80, 83, the respective wallets 85, 87, 90 are updated with the respective distribution of the ABC currency mined.

With reference to FIG. 1B, a system component diagram showing the relationship of the components of an illustrative embodiment of the present invention is shown. In this embodiment, the ABC host 100 combines the functions of the catalog of media files, the content server, a log file of content served to a specific client IP, and the ABC Host wallet.

The ABC Client 105 provides the media content player and browser, a local log file of all content viewed or listened to, depending upon the nature of the content streamed to the media player, the ABC Listener wallet, and identity confirmation of the user/member authorized on the ABC system.

The ABC Wallet 110 stores information regarding account keys, current account totals for each user, artist and host server, content receipt (listening, in the case of music files) and the functionality to initiate and receive ABC transactions.

The ABC Artist Database 115 stores information about participant artists who may earn ABC currency. The database may be encrypted, storing artist Wallets and IDS in order to earn ABC currency. The artist database 115 does not serve content directly, nor can it mine currency unless a transaction is initiated by an ABC Client 105 and ABC Host 100 pair. Rather, the ABC Artist Database 115 stores a record of the file size and duration of each unit if streamed content, and confirms the actual files served against the ABC Artist Database115. It also stores ABC Artist wallet accounts.

Referring to FIG. 1C, a diagram 118 of one embodiment of a distributed ABC system is provided. The ABC system may contain several content hosts 120, 125, each of which may stream content to clients 130, 135 and 140. Each host and client maintains record of their respective wallets 145, 150, 155, 160, 165, 170, 175, 180, 185 and 190. Regardless of what host 125, 120 a client 130, 135, 140 may receive content from, each host and client may communicate directly with the ABC Artist Database 195 to verify and authorize each transaction.

THE ABC Blockchain is a transparent peer-to-peer ledger of the entire transaction history of ABC currency, similar to that utilized by Bitcoin.

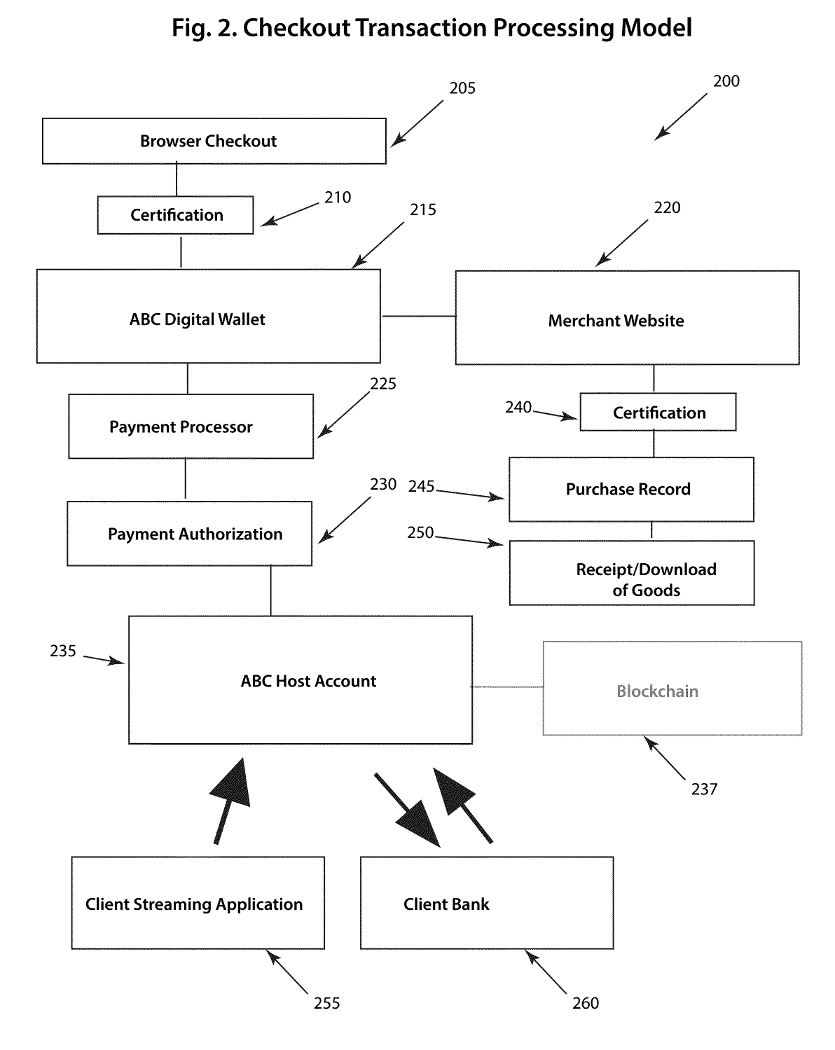

Referring to FIG. 2, an exemplary checkout transaction-processing model of one embodiment of the present invention 200 is shown. An owner of ABC currency contained within the owner's digital wallet wishes to pay for a transaction utilizing ABC currency. The user, at a website that accepts ABC currency, selects one or more products and proceeds to checkout. The user provides credentials 215 to authenticate that the user is in fact the owner of a digital wallet 215 containing ABC currency. The user instructs a payment processor to provide the required purchase price in ABC currency. The authorization is communicated to an ABC Host account, which confirms that the user has the requisite balance in his or her account. If there is sufficient balance, the merchant account is credited by recording the transaction in the ABC blockchain 237. The transaction then is certified 240 to the merchant. A purchase record is made and the merchant authorizes the release of goods 250 to the user.

The ABC Host server continues as required to process transactions form a client streaming application 255, and may also provide exchange transactions with a client bank, converting dollars to ABC currency and vice versa.

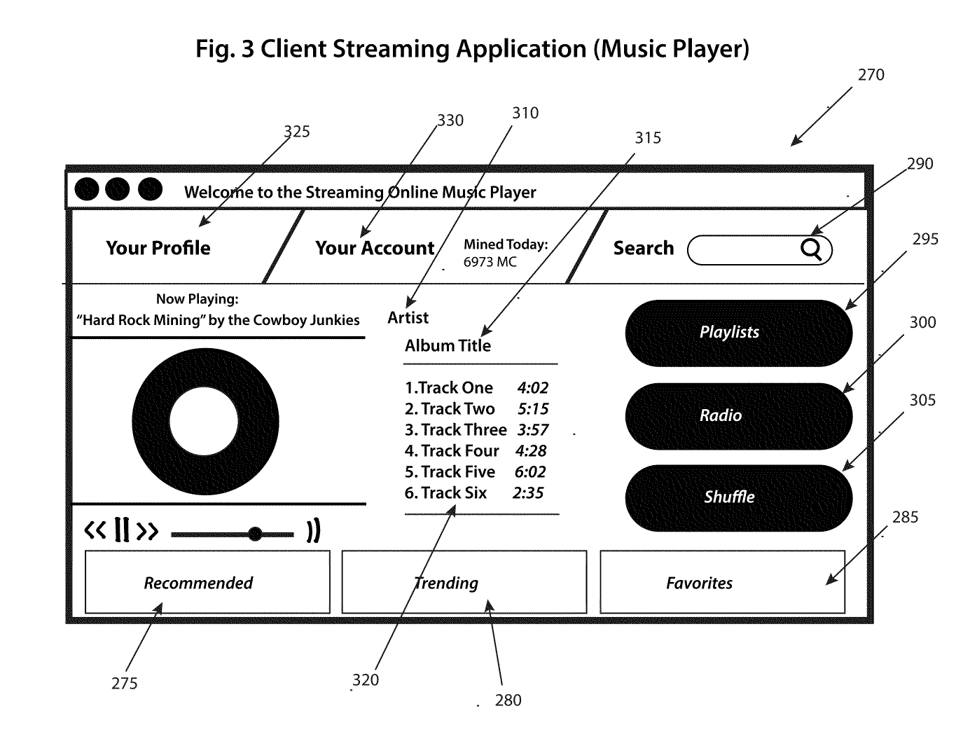

Referring to FIG. 3, an exemplary client streaming application screen is shown. In this embodiment, the streamed content is songs. The actual screen content and functionality of client streaming application may be different and still be within the scope of the present invention.

The client streaming application is similar to existing streaming applications in that it provides for selection of music from recommended music 275, trending music 280 and favorites 285, as well as a search function, to find songs meeting search criteria. It may, in this embodiment, be set to play from user-defined playlists 295, or radio station mode 300 which would play music from a selected genre or composer or artist. There is a shuffle mode 305 to allow randomization of the order in which songs are played. At the center of the screen is a display of the current artist 310, album title 315 and track names queued to play 320. There is a button to display the user account details.

As described in the preceding paragraph there is nothing new in the Client Streaming Application. However, unique to the ABC system is the accounting for mining of ABC currency earned 330.

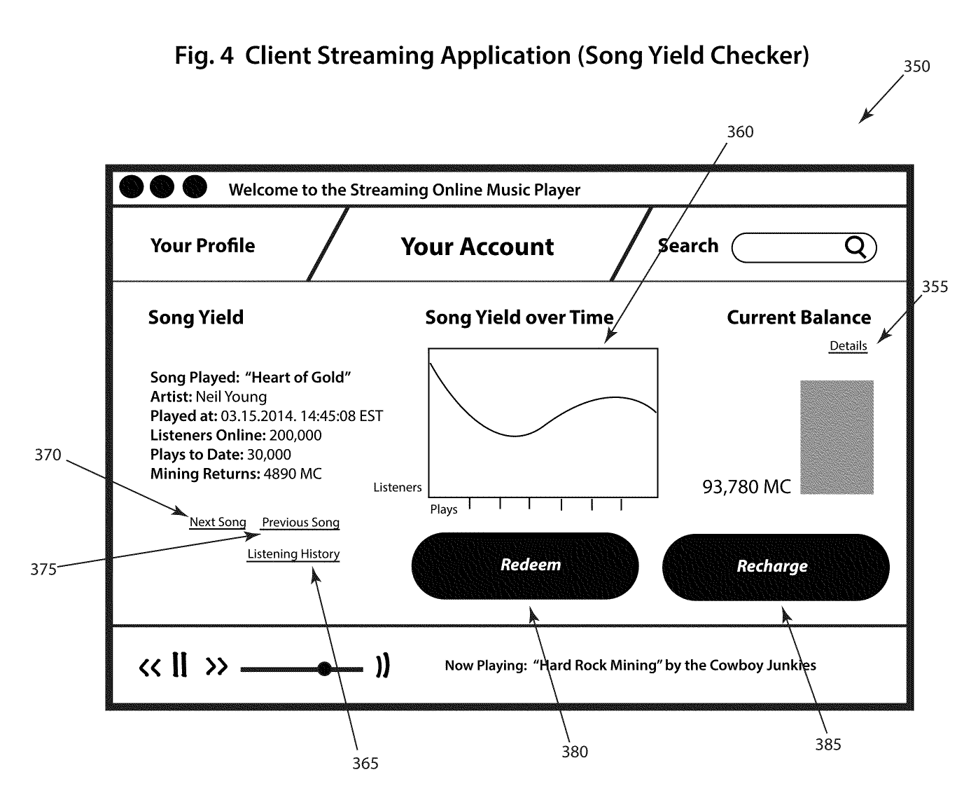

Referring to FIG. 4, an exemplary embodiment of a client streaming application song yield screen 350 is shown. It shows account balance of ABC currency 355, and the current mining yield an individual song streamed 360. A user can thereby get information about how his listening history 365 has been rewarded with mined ABC currency, and how individual songs have yielded by selecting the next song 370 or previous song 375. Users may redeem ABC currency for, e.g., music downloads and other goods and services, by pressing the Redeem button 380 or purchase ABC currency by pressing the Recharge button 385, which takes them to a currency exchange screen (not shown).

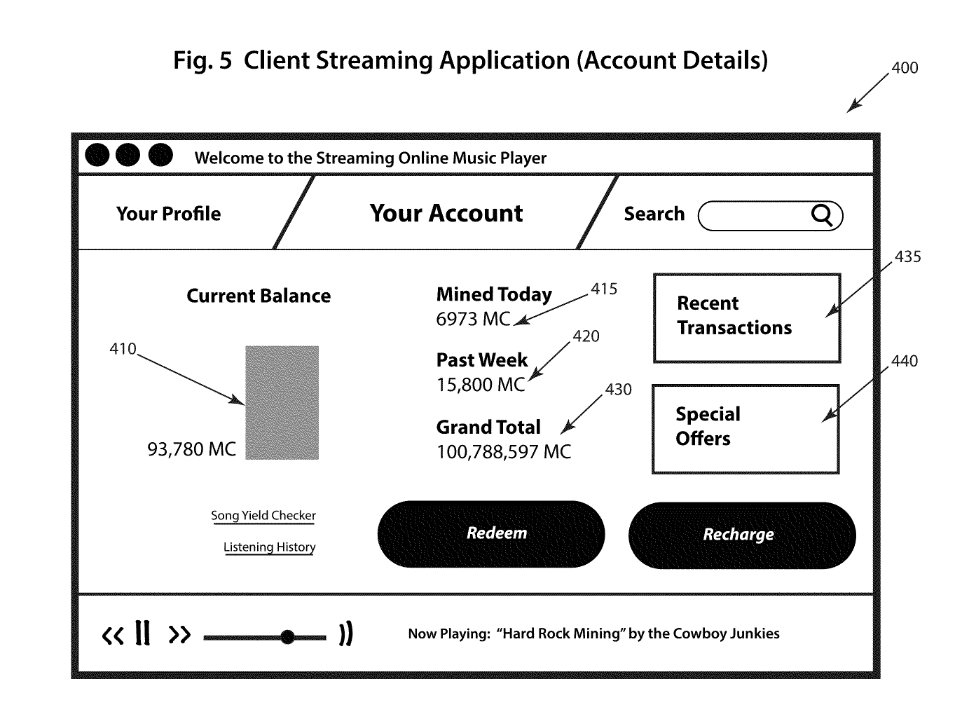

Referring to FIG. 5, an exemplary embodiment of a client streaming application account screen 400 is shown. In this embodiment, the account screen shows current account balance of ABC currency 410, as well as a mining history, showing the amount of currency mined today 415, the amount earned during the past week 420 and the grand total of all mining 430. Additional information buttons, such as recent transactions 435 or special offers 440 and the like may be provided. For a detailed listening and yield history a Listening History link 445 is provided.

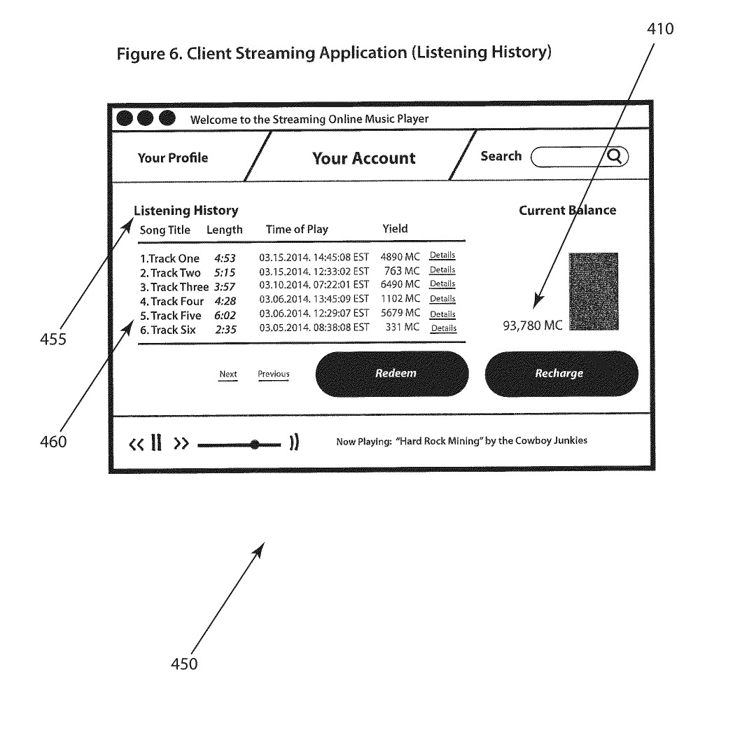

Referring to FIG. 6, an embodiment of a client streaming application listening history screen 450 is shown. Total account balance of ABC Currency 410 is shown, and a Listening History panel 455 is shown showing individual songs and details 460.

ABC is similar to “pooled” crypto-currencies well known in the art in that it requires a network connection to generate currency units. However, ABC differs from Bitcoin and other distributed cryptocurrencies in that it permits connection to a central artist database for authentication and verification of currency creation in addition to the distributed blockchain utilized by Bitcoin and similar currencies. While ABC incorporates key features of peer-to-peer cryptocurrencies such as a blockchain, some degree of centralization is required in order to protect against piracy and make possible a business model that includes a competitive selection of songs and compensates musicians for their work.

In a preferred embodiment, Attention Based Currency has a listener-targeted database of approximately fifteen to thirty million songs, similar to the music databases currently in use by other existing commercial streaming sources. Additional lesser-known original material beyond what is currently available in commercial song databases is also desirable.

In this embodiment, a “song” is typically any audio selection between 1 and 10 minutes in length. Other lengths may also be beneficially utilized. Songs may also include spoken word, comedy, hip-hop, etc. Longer selections (e.g. audiobooks) and may also be included as part of the ABC online streaming audio selection.

A user signs up for an ABC account using a secure web form to provide an email address, first and last name, and a confirmation that the user is human and not a Bot. Several human confirmation schemes are well known in the art, such as CAPTCHA and identity verification by SMS text. Credit card or bank information is not required to create an account—nor is download or installation of the ABC client streaming application that enables generation of currency.

Much like Bitcoin, ABC can be traded, exchanged, and funded independently, regardless of whether “mining” activity has taken place.

Upon sign-up, the user is assigned a unique account identifier and is given login privileges for a secure ABC Digital Wallet that can be used to make purchases and track account activity across different devices and Internet websites.

In order to generate currency, the user must download and install an ABC Client Streaming Application (CSA) to play music and connect to the central ABC server. CSAs are designed to run on any suitable platform capable of connecting to a network such as the Internet, such as smart phones such as Android or Apple iPhones, tablets, such as tablets and iPads, or laptop or desktop computers, or purpose-built platforms similar to Internet appliances. Such CSAs must be connected to the Internet in order to generate currency. Every time a song is played from beginning to completion, a unit of currency is generated. Such units may be fractional parts of ABC currency units. If the user skips or fast-forwards in the middle of a song, no currency is mined.

The amount of currency generated is determined by a formula, which may change over time. The user receives a portion of the currency determined by the popularity of the song and the number of current listeners; the remainder of the currency unit generated is divided between the host and the artist, or artists.

For example, the currency generation formula may be weighted to favor songs with fewer plays, such that paying them returns greater rewards for listeners, rewarding listeners who seek out new and unfamiliar artists, and encouraging gaming of the system in a positive, easily observable manner. The currency generation formula may be adjusted as desired to provide for different incentives.

For example:
Listener (L) share may be set to equal the number of current listeners of a song, divided by the number of times a particular song has been played.
Host (H) share may be set to the reciprocal fraction of listener share.
Artist (A) share may be set to equal one half of the unit of currency generated.
Unit of Currency (UC) represents one unit of currency [ABC units of currency may be subdivided into smaller fractional denominations, similar to Bitcoin. For instance, if we set 1,000 mille coins (MC) equal to 1 UC, we get the following values for the song played below: Listener Share 4950 MC, Host Share 5 0 MC, Artist Share 5000 MC.]

Thus, a song with 100 listeners and 10 plays would yield an L value of 10. H value would be 1/10. The A value would be ½ UC.

Using the equation:

(L×H)/2×UC+A=UC

We can solve to get the following currency values generated by one play:

Listener Share=0.495049505 UC

Host Share=0.004950495 UC

Artist Share=0.5 UC

In one embodiment, the cash value of 1 UC is a fractional equivalent of a dollar. The currency is floating, rather than fixed.

In yet another embodiment, ABC uses a blockchain, or public ledger, such as that used by Bitcoin, and well known in the art, to create a database with a sequential record of all transactions. This embodiment provides value by providing a receipt of currency generated and/or exchanged, and creating a way to verify transactions. In this embodiment, care is preferably taken to protect the privacy of all user accounts and prevent the release of personally identifying information associated with user accounts, such as specific listening patterns.

The CSA functions in most ways so as to be indistinguishable from a standard online jukebox or music streaming application. Embodiments include one ore more of the following features:
Song Play by Artist
Song Play by Album
Song Play by Genre
Pre-Programmed Playlists
“Shuffle” or “Random” Mode
Internet Radio Stations
Social Media Integration

Listeners may simply use the CSA as their preferred musical listening platform and may not wish to track or closely monitor the currency mining functionality. The mining formulas are preferably structured so that individuals with the most conventional listening tastes (e.g. the majority of listeners) will reap comparatively fewer rewards from ABC “mining.” This means that the most popular artist streams) will generate the most currency for the host; conversely, users who seek out independent and less well-known artists, whether for musical or currency-seeking motives, will be rewarded for their more adventurous tastes.

Users may install the CSA on more than one device; however only one device may generate currency at a time for a given user account identifier. All currency-generating transactions are logged on the blockchain and assigned a timestamp to reduce the possibility of fraud. In yet another embodiment, users may listen to their favorite tracks off-line; however, off-line listens will not count toward generating currency.

The system is set up so that all users have a Dashboard (FIG. 5) to check their online balance and recent listening history. Statistics on returns from popular and trending songs and on the quantity and current value of currency generated system-wide will also be accessible through this dashboard.

In addition, users can check their ABC balance by logging in via the web or their cell phones to their secure ABC Digital Wallet, which is synced in real-time with the client CSA.

The host may at times wish to award ABC currency as a bonus or one-time incentive to users (for instance, when running a contest or funding initial account signups with a starting balance); however, after initial launch, all new currency will be generated through the ABC Client Streaming Application, based on users' interactions with their chosen streaming musical selections.

Demographic user listening data may be shared with outside sources, but only anonymously, in the aggregate. Transparent, accurate reporting data on songs, usage, and listening patterns is considered to be essential to instill confidence in Attention Based Currency.

Preferred embodiments of include effective and sustained deployment of CAPTCHA technology and forms. CAPTCHA is an acronym that stands for Completely Automated Public Turing test to tell Computers and Humans Apart. In short, a CAPTCHA form is an “Are You Human?” test, employing such devices as graphical representations of numbers, letters, and phrases, which a human being (but not a computer program) will be able to read.

It is desirable to avoid 'bots and automated processes impersonating human beings and generating fraudulent currency without listening to songs. CAPTCHAs will appear at designated intervals to determine whether the user is still present, still listening, and is in fact a human being. CAPTCHA alternatives such as client-side check boxes, simple natural language questions, and interactive games may also be deployed. [See “Are You Human?” http://areyouahuman.com/.]

In yet another embodiment, users who wish to bypass CAPTCHAs may do so for a fee. This accesses level of premium membership may also include better sound quality and other perks.

CAPTCHA-bypass fees represent another way to fund the ABC system; similar to the subscription model currently employed by many commercial online streaming music services.

CAPTCHA alternatives will be implemented so that users with disabilities may still use the system.

Songs or other streaming content of more than 10 minutes and other long-format selections such as audiobooks or standup comedy may be included in the song database. In this instance, these selections may be weighted with a multiplier so that their currency more nearly approximates listening to shorter selections for an equivalent length of time. However, long-format selections will periodically be interrupted by CAPTCHA-type programming unless a premium membership is purchased.

At the time of account signup, a secure individual ABC Digital Wallet is created, with a unique login and user identifier. This wallet can be used to make purchases and track account activity across different devices and on any Internet website accepting ABC as currency. This wallet may be funded through one of several sources:
Initial sign-up bonus
Currency generated by listening songs via the centrally hosted ABC CSA
Conversion of currency into ABC via credit card or bank account
Transfer of ABC funds by individuals or businesses (typically for the sale of goods or services—ex. an artist receives ABC compensation for download and use of digital stock photography)

This ABC Digital Wallet may be accessed online through any web browser or supported mobile device. In addition, the Digital Wallet may be integrated with leading social networks and online experience sites. (For example, a user might employ the ABC Digital Wallet to purchase in-game credits, such as FarmVille credits on Facebook, or to download an article from the Wall Street Journal. In both cases, no additional credit card or login information would be needed.)

Digital Wallet transactions may be verified through a blockchain, or public ledger database, maintained by the ABC host. While informational aspects of this database, such as the total amount of currency minted and the songs played is typically made public, the personally identifying user information of Digital Wallet account holders shall not be revealed.

Login may be associated with other leading online service providers (e.g. Facebook, Google, Apple)—however one unique account per email address is still required. Credit card or bank account information is not necessary to create an ABC account or use the Digital Wallet; however the user may supply this information if they wish to exchange ABC for cash, or purchase additional ABC units for future transactions.

Individuals and merchants wishing to accept payments online using ABC may download a simple client-side script to install a “Buy with ABC” button and set an item's price. Merchants with more complex needs may use an Application Programming Interface (API) to customize their online storefront while securely integrating the storefront with ABC.

When a user clicks the “Buy with ABC” button, the system searches for an online token indicating that the buyer is logged into their ABC Digital Wallet and has a current ABC account. If this token is located, the system queries the account and deducts the cost of the item, as long as the buyer's account is funded. The ABC blockchain may then be updated. A receipt and “thank you” message then appears on the website storefront.

If no token is located, and the buyers does not appear to be logged into their Digital Wallet, then the buyer instead is directed to a screen within a login prompt. The buyer then logs into the ABC Digital Wallet and continues their transaction, updating the blockchain and Digital Wallet account balance as specified.

Alternatively, in yet another embodiment, ABC may also be used beneficially for a more traditional “points” or “credit” system, in which ABC units have no cash value, but may be redeemed for other goods, services, and information transfers (e.g. music downloads, e-books) within the ABC system.

In such an implementation, ABC “points” function as a unique and novel way to compensate musicians for their work. In the same way that major record labels once subsidized niche releases through the sales of major hits, ABC “points” provide extra incentive for listeners to seek out less well-known songs. This new model helps restore economic sustainability to an industry that has been severely undercut by the digitization of music.

ABC may also be used in conjunction with conventional magnetic-stripe charge cards and Point of Sale (POS) card reading technology.

This invention also encompasses development of an Application Programming Interface (API) enabling listeners to other commercial streaming services to participate in generating ABC. Such an API is typically licensed and proprietary; currency units generated are subject to the same rules and standards as those generated within the original, native, centrally hosted CSA.

Additional specific applications and implementations of Attention Based Currency include:
ABC systems that include interaction with video, text, still pictures, or interactive games as measurements of attention, in addition to or in place of interaction with music.
ABC visualization modules that graphically represent aggregate trends in attention and interaction, through a variety of informational or abstract patterns
ABC modules for social media that share what songs a particular listener is listening to and how much currency has been minted
ABC QR codes (Quick Response Codes) enabling a user to scan a particular artist's code on a mobile device and immediately begin listening to their songs
“Pay with ABC” icon and menu option available for images on popular photo upload sites. This icon convention may also be employed for download of apps, games, text files, and other forms of electronic content download.
Opportunity for CSA listeners to participate in surveys and other forms of demographic data collection, in place of CAPTCHA surveys, or as a way to supplement ABC mining.
Generation of industry music reports (“charts”) based on ABC listening trends.
Issuance of ABC credit or debit cards.
ABC “value checker” application and mobile phone app that compares ABC value to other forms of currency
Ability to designate a portion of ABC spending and/or proceeds to a given business, individual, or charity. For example, a musical artist can designate their Artist Share of currency generated go to the charity of their choice.
An implementation of ABC that includes a preset maximum amount of currency to be minted, and decreases the amount of currency generated proportionally, as more users join the system.
A hosted Digital Wallet that automatically tracks any capital gains taxes that may at be assessed on the currency.
Automatic tracking technology for any capital gains taxes that may at a future point be assessed on the currency, to be integrated into the Client Streaming Application (CSA), payment checkout process, signup process, and any other technologies to be developed to mine or conduct transactions with ABC.
An alternate implementation of ABC is the “Peer-to-Play” (P2P) model. More closely resembling the Peer-to-Peer model of established crypto-currencies such as Bitcoin, “Peer-to-Play” is more decentralized mode. This approach is similar to the Licensed API structure outlined above, but—to the extent that current copyright law and policy permits—is a truly decentralized approach. This implementation does not include a centralized server for any purpose other than establishment or duplication of the blockchain registry, which includes a record and timestamp of all songs played, and a record of the variables (number of users listening and number of song plays) determining shares of currency per song. This implementation would not contain a single digital wallet; however the ABC host may still enter this market and provide a digital wallet option for interested consumers. The purpose of the ABC host in this implementation is more akin to ICANN (Internet Corporation for Assigned Named and Numbers), assigning qualified music streaming hosts cryptographic keys that enable them to participate in a shared, decentralized ABC mining protocol—while screening and establishing strict conventions to prevent piracy and unauthorized use of copyrighted material. The ABC host may participate in currency generation according to this model; however, the P2P model, responsibility for security of individual financial accounts does not rest with a single central entity.

A portion of the disclosure of this patent document contains or may contain material, which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention.

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

What is claimed is:

1. An attention based currency system comprising:
at least one ABC Host connected to and configured store a database of enrolled users, and further a database of enrolled media content owners, and further a record of ABC currency transactions, and further configured to communicate on a network;
at least one streaming host media operable to store and serve a collection of digital content available for streaming, said host media server being connected to and configured to communicate on a network;
at least one client media player connected to and configured to communicate on a network and to request and receive streamed media content;
each of the said at least one ABC Host, said at least one host media server and said at least one client media server having: a computer, computer memory, a processor for storing and receiving instructions from the memory and a network interface operably connecting the said processor to a network communications medium;
wherein the said client media player is configured to enable a user to request said at least one host media server to stream content to said client media server and to report the streaming of content to said art least one ABC Host;
wherein the said host media server is configured to report said streaming to said ABC Host;
wherein the said at least one ABC host receives the report of said streaming from each of said at least one client media player and said at least one host media server and applies a formula based on the identity of said streamed content which formula application results in a sum of ABC Currency being generated.

2. The system of claim 1 wherein each of the reports from the said client media player and Host media server includes identification of the owner of said streamed content, and further that the report form the said at least one client media player contains identification of the client media player user, and wherein the said at least one ABC hosts verifies that the owner of the streamed media content so identified is contained within the said database of enrolled media content owners; and further wherein the said at least one ABC Host verifies that the identified client media player user is an enrolled user; and further that no ABC currency is generated unless both said verifications are confirmed.

3. The system of claim 2, further comprising the report from said at least one media host controller containing a report of whether the said streamed content was streamed from beginning to end without interruption or skip, and further that no ABC currency is generated unless said streamed media content was streamed from beginning to end without interruption or skip.

4. The system of claim 1 further wherein the said at least one host media server is configured to insert one selected from the group consisting of CAPTCHAs and voice at selected intervals in the streamed content and to require verification as to whether the client media player user is both human, present and attentive to the said streamed media content.

5. The system of claim 3 wherein the ABC currency generated is distributed according to a a selected sharing formula between said at least one client media player user, said at least one media host controller and said owner of the streamed media content.

6. The system of claim 5 wherein such sharing is recorded in a blockchain containing a sequential record of all ABC currency transactions.

7. The system of claim 6 wherein said block chain is a distributed public ledger.

8. The system of claim 1 wherein the streamed media content is at least one selected from the group consisting of songs, audio book recordings, digital images, videos, software applications, games, online gaming tokens, electronic books, and music.

9. The system of claim 1 wherein the said formula may vary depending upon one or more of the factors selected from the list consisting of media content owner, popularity of said media content, promotional considerations, time of day of said streaming, and number of users simultaneously streaming said streamed media content.

10. The system of claim 6 wherein said blockchain is maintained by a central ABC host.

11. The system of claim 6 wherein said blockchain is maintained by a plurality of peer to peer ABC Hosts at a plurality of physical locations.

12. A method of generating attention based currency system comprising the steps of:
providing at least one ABC Host having: a computer, computer memory, a processor for storing and receiving instructions from the memory and a network interface operably connecting the said processor to a network communications medium;
storing on said at least one ABC Host a database of enrolled users and a database of enrolled media content owners and a record of ABC currency transactions;
providing at least one streaming host media server having: a computer, computer memory, a processor for storing and receiving instructions from the memory and a network interface operably connecting the said processor to a network communications medium;
storing on said at least one streaming host media server a selection of media content available for streaming;
providing at least one client media player, said client media player having: a computer, computer memory, a processor for storing and receiving instructions from the memory and a network interface operably connecting the said processor to a network communications medium;
storing user identification information on the client media player;
a client media player user selecting desired media content;
transmitting to said at least one host media server over said network communications medium a request from said at least one client media player to stream selected media content which request includes client media player user identification information;
the host media server streaming to the requesting client media player the requested content over the said network communications medium;
the said at least one client media player receiving the selected media content from said at least one host media server;
at least one of the client media player and the host media server transmitting a report to said at least one ABC Host the said user identification information and the identity of the streamed media content;
the ABC host receiving the report of said streaming and user identification information from at least one of said at least one client media player and said at least one host media server;
the ABC host applying a formula based at least in part on the identity of said streamed content which formula application results in a sum of ABC Currency being generated.

13. The method of claim 12 comprising the further step of the ABC Host verifying that the owner of the identified streamed media content is contained within the said database of enrolled media content owners; and further wherein the said at least one ABC host verifies that the identified client media player user is an enrolled user; and further only allowing ABC currency to be generated if both said verifications are confirmed.

14. The method of claim 13, comprising the further step of said at least one media host controller reporting to said at least one ABC Host whether the said streamed content was streamed from beginning to end without interruption or skip, and further only allowing ABC currency to be generated if said streamed media content was streamed from beginning to end without interruption or skip.

15. The method of claim 12 further comprising the step of said of the host media server at selected intervals inserting into the streamed media content one selected from the group consisting of CAPTCHAs and voice prompts, and requiring verification from said client media player user through said client media player confirming that the said user is both human, present and attentive to the said streamed media content.

16. The method of claim 14 further comprising the step of sharing the generated ABC currency according to a selected sharing formula allocating the generated ABC currency between said at least one client media player user, said at least one media host controller and said owner of the streamed media content.

17. The method of claim 16 further comprising the step of recording the sharing of ABC currency in a blockchain containing a sequential record of all ABC currency transactions.

18. The method of claim 17 wherein said block chain is a distributed public ledger.

19. The method of claim 12 wherein the streamed media content is at least one selected from the group consisting of songs, audio book recordings, digital images, videos, software applications, games, online gaming tokens, electronic books, and music.

20. The method of claim 12 wherein the said formula may vary depending upon one or more of the factors selected from the list consisting of media content owner, popularity of said media content, promotional considerations, time of day of said streaming, number of users simultaneously streaming said streamed media content.

21. The method of claim 17 further comprising the step of maintaining and updating said blockchain by said at least one ABC host.

22. The method of claim 17 further comprising the step of maintaining said blockchain by a plurality of peer to peer ABC Hosts at a plurality of physical locations.
